(19) United States
(12) Patent Application Publication
(10) Pub. No.: US 2025/0313754 A1
(43) Pub. Date: Oct. 9, 2025

(54) Black Liquid Crystalline Polymer Composition With Low Dissipation Factor

(71) Applicant: Ticona LLC, Florence, KY (US)

(72) Inventor: Shuai Xu, Shanghai (CN)

(21) Appl. No.: 18/835,043

(22) PCT Filed: Dec. 29, 2022
(86) PCT No.: PCT/CN2022/143277

§ 371 Date: Aug. 1, 2024

(51) Int. Cl. C09K 19/38; C09K 19/52

(52) U.S. Cl. CPC C09K 19/3809; C09K 2019/521

(57) ABSTRACT

A polymer composition comprising a liquid crystalline polymer matrix and carbon black particles dispersed within the polymer matrix is provided. The carbon black particles constitute from about 0.1 wt. % to about 3 wt. % of the composition. The composition exhibits a dissipation factor less than 0.002 when measured at a frequency of 10 GHz and a lightness (L*) of less than about 60.

### BACKGROUND OF THE INVENTION

Electrical components often contain molded parts that are formed from a liquid crystalline, thermoplastic resin. Recent demands on the electronics industry have dictated a decreased size of such components to achieve desired performance and space savings. In 5G applications, for example, there is a desire to form parts (e.g., circuit boards, filters, antenna covers, connectors, etc.) from polymers with low dielectric loss to limit signal attenuation during high-speed transmission. Additionally, there is often a desire to reduce reflectance of light from the polymer resin, for example, to better view metal circuitry components formed on a liquid crystalline polymer film. For this reason, carbon black is often used as a colorant. However, the use of carbon black increases the dielectric loss of liquid crystalline polymer compositions. Thus, there is a need for a black liquid crystalline polymer composition with low dielectric loss.

### SUMMARY OF THE INVENTION

In accordance with one embodiment of the present invention, a polymer composition comprising a liquid crystalline polymer matrix and carbon black particles dispersed within the polymer matrix is disclosed. The carbon black particles constitute from about 0.1 wt. % to about 3 wt. % of the composition. The composition exhibits a lightness (L*) of less than about 60 and a dissipation factor of about 0.002 or less when measured at a frequency of 10 GHz.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 depicts one embodiment of a 5G antenna system that can employ a circuit board or connector formed according to the present invention;

FIG. 2A illustrates a top-down view of an example user computing device including 5G antennas;

FIG. 2B illustrates a side elevation view of the example user computing device of FIG. 2A;

FIG. 3 illustrates an enlarged view of a portion of the user computing device of FIG. 2A;

FIG. 4 illustrates a side elevation view of co-planar waveguide antenna array configuration that can be employed in a 5G antenna system;

FIG. 5A illustrates an antenna array for massive multiple-in-multiple-out configurations of a 5G antenna system;

FIG. 5B illustrates an antenna array formed that can be employed in a 5G antenna system;

FIG. 5C illustrates an example antenna configuration that can be employed in a 5G antenna system;

FIG. 6 is a schematic view of one embodiment a laminate that can be formed according to the present invention;

FIG. 7 is a schematic view of another embodiment a laminate that can be formed according to the present invention;

FIG. 8 is a schematic view of yet another embodiment a laminate that can be formed according to the present invention; and

FIG. 9 is a schematic view of one embodiment of an electronic device that may be employ the circuit board of the present invention.

FIG. 10A depicts a thin-walled electrical connector according to aspects of present invention;

FIG. 10B depicts an enlarged view of a portion of thin-walled connector of FIG. 1A; and

FIG. 11 is an exploded perspective view of another embodiment of a thin-walled connector and connector receptacle that may be formed according to the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition containing a liquid crystalline polymer matrix and carbon black particles dispersed within the matrix. By selectively controlling the particular nature and concentration of the components of the polymer composition, the present inventor surprisingly discovered that the resulting composition could exhibit both a dark color and an ultra-low dissipation factor over a wide range of frequencies, making it particularly useful for forming components of 5G systems, such as circuit boards in antennas and high-speed connectors. That is, the dissipation factor of the polymer composition, which is a measure of the loss rate of energy, may be about 0.002 or less, in some embodiments about 0.001 or less, in some embodiments from about 0.0001 to about 0.001, and in some embodiments from about 0.0005 to about 0.0009 over typical 5G frequencies (e.g., 10 GHZ). The polymer composition may also exhibit a low dielectric constant of about 6 or less, in some embodiments about 5 or less, in some embodiments from about 1 to about 4.5, and in some embodiments, from about 2 to about 4 over typical 5G frequencies (e.g., 10 GHZ).

The use of the carbon black in selectively controlled concentrations can provide the composition with a relatively dark color. Darkness can be quantified by measuring the absorbance with an optical reader in accordance with a standard test methodology known as “CIELAB”, which is described in Pocket Guide to Digital Printing by F. Cost, Delmar Publishers, Albany, N.Y. ISBN 0-8273-7592-1 at pages 144 and 145 and “Photoelectric color difference meter”, Journal of Optical Society of America, volume 48, page numbers 985-995, S. Hunter, (1958), both of which are incorporated herein by reference in their entirety. More specifically, the CIELAB test method defines three “Hunter” scale values, L*, a*, and b*, which correspond to three characteristics of a perceived color based on the opponent theory of color perception. L*=Lightness (or luminosity), ranges from 0 to 100, where 0=dark and 100=light.

The lightness value (L*) of the composition can be less than about 60, in some embodiments from about 30 to about 57, in some embodiments from about 40 to about 54, in some embodiments, from about 45 to about 50, and in some embodiments, from about 46 to about 48.

Conventionally, it was believed that polymer compositions exhibiting a low dissipation factor would not also possess sufficiently good thermal and mechanical properties and ease in processing (i.e., low viscosity) to enable their use in certain types of applications, such as to mold connectors. Contrary to conventional thought, however, the polymer composition has been found to possess both excellent thermal and mechanical properties and processability. For example, the melting temperature of the polymer composition may, for instance, be about 200° C. to about 400° C., in some embodiments from about 250° C. to about 380° C., in some embodiments from about 270° C. to about 360° C., and in some embodiments from about 300° C. to about 350° C. Even at such melting temperatures, the ratio of the deflection temperature under load (“DTUL”), a measure of short-term heat resistance, to the melting temperature may still remain relatively high. For example, the ratio may range from about 0.5 to about 1.00, in some embodiments from about 0.6 to about 0.95, and in some embodiments from about 0.65 to about 0.85. The specific DTUL values may, for instance, be about 200° C. or more, in some embodiments from about 200° C. to about 350° C., in some embodiments from about 210° C. to about 320° C., and in some embodiments, from about 230° C. to about 290° C. Such high DTUL values can, among other things, allow the use of high speed and reliable surface mounting processes for mating a structure formed from the composition with other components in an electrical component.

The polymer composition may also possess excellent mechanical properties, which can be useful when forming substrates. For example, the polymer composition may exhibit a tensile strength of about 10 MPa or more, in some embodiments about 50 MPa or more, in some embodiments from about 70 MPa to about 300 MPa, and in some embodiments from about 80 MPa to about 200 MPa. The polymer composition may exhibit a tensile elongation of about 0.3% or more, in some embodiments about 0.4% or more, in some embodiments from about 0.5% to about 4%, and in some embodiments from about 0.5% to about 2%. The polymer composition may exhibit a tensile modulus of about 5,000 MPa or more, in some embodiments about 6,000 MPa or more, in some embodiments about 7,000 MPa to about 25,000 MPa, and in some embodiments from about 10,000 MPa to about 20,000 MPa. The tensile properties may be determined at a temperature of 23° C. in accordance with ISO Test No. 527:2019. Also, the polymer composition may exhibit a flexural strength of about 20 MPa or more, in some embodiments about 10 MPa or more, in some embodiments about 50 MPa or more, in some embodiments from about 70 MPa to about 300 MPa, and in some embodiments from about 80 MPa to about 200 MPa. The polymer composition may exhibit a flexural elongation of about 0.4% or more, in some embodiments from about 0.5% to about 4%, and in some embodiments from about 0.5% to about 2%. The polymer composition may exhibit a flexural modulus of about 5,000 MPa or more, in some embodiments about 6,000 MPa or more, in some embodiments about 7,000 MPa to about 25,000 MPa, and in some embodiments from about 10,000 MPa to about 20,000 MPa. The flexural properties may be determined at a temperature of 23° C. in accordance with 178:2010. Furthermore, the polymer composition may also possess a high impact strength, which may be useful when forming thin substrates. The polymer composition may, for instance, possess a Charpy notched impact strength of about 3 KJ/m² or more, in some embodiments about 5 KJ/m² or more, in some embodiments about 7 KJ/m² or more, in some embodiments from about 8 KJ/m² to about 40 KJ/m², and in some embodiments from about 10 KJ/m² to about 25 KJ/m². The impact strength may be determined at a temperature of 23° C. in accordance with ISO Test No. ISO 179-1:2010.

Various embodiments of the present invention will now be described in more detail.

### I. Polymer Composition

### A. Liquid Crystalline Polymer Matrix

The polymer composition contains one or more liquid crystalline polymers, generally in an amount of from about 40 wt. % to about 99.9 wt. %, in some embodiments from about 50 wt. % to about 90 wt. %, in some embodiments from about 60 wt. % to about 80 wt. %, and in some embodiments, from about 65 wt. % to about 70 wt. % of the entire polymer composition. Liquid crystalline polymers are generally classified as “thermotropic” to the extent that they can possess a rod-like structure and exhibit a crystalline behavior in their molten state (e. g., thermotropic nematic state). The liquid crystalline polymers employed in the polymer composition typically have a melting temperature of from about 200° C. to about 400° C., in some embodiments from about 250° C. to about 380° C., in some embodiments from about 300° C. to about 370° C., in some embodiments from about 330° C. to about 360° C., and in some embodiments, from about 345° C. to about 355° C. The melting temperature may be determined as is well known in the art using differential scanning calorimetry (“DSC”), such as determined by ISO Test No. 11357-3:2011. Such polymers may be formed from one or more types of repeating units as is known in the art. A liquid crystalline polymer may, for example, contain one or more aromatic ester repeating units generally represented by the following Formula (I):

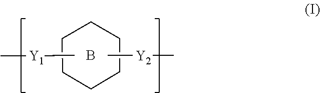

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 30 mol. % to about 100 mol. %, in some embodiments about 40 mol. % to about 80 mol. %, in some embodiments from about 45 mol. % to about 65 mol. %, and in some embodiments, from about 50 mol. % to about 60 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 40 mol. %, in some embodiments from about 10 mol. % to about 35 mol. %, and in some embodiments, from about 20 mol. % to about 30% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 40 mol. %, in some embodiments from about 10 mol. % to about 35 mol. %, and in some embodiments, from about 20 mol. % to about 30% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 20 mol. % or more, in some embodiments from about 30 mol. % to about 95 mol. %, in some embodiments from about 35 mol. % to about 80 mol. %, in some embodiments from about 40 mol. % to about 60 mol. %, and in some embodiments, from about 45 mol. % to about 50 mol. % of the polymer. Contrary to many conventional “low naphthenic” polymers, it is believed that the resulting “high naphthenic” polymers are capable of exhibiting good thermal and mechanical properties. Additionally, the present inventor has discovered that the use of a liquid crystalline polymer containing a relatively high HNA content can result in a composition having an exceptionally low dissipation factor. For instance, the repeating units derived from HNA may constitute from about 20 mol. % or more, in some embodiments about 20 mol. % or more, in some embodiments from about 30 mol. % to about 85 mol. %, in some embodiments from about 35 mol. % to about 75 mol. %, in some embodiments from about 40 mol. % to about 60 mol. %, and in some embodiments, from about 45 mol. % to about 50 mol. % of the polymer. In such embodiments, the liquid crystalline polymer may contain the naphthenic monomers (e.g., HNA and/or NDA) in the amounts specified above in combination with various other monomers, such as aromatic hydroxycarboxylic acid(s) (e.g., HBA) in an amount of from about 70 mol. % or less, in some embodiments about 60 mol. % or less, in some embodiments about 40 mol. % or less, in some embodiments about 20 mol. % or less, in some embodiments from about 1 mol. % to about 10 mol. %, and in some embodiments, from about 2 mol. % to about 5 mol. %; aromatic dicarboxylic acid(s) (e.g., IA and/or TA) in an amount of from about 1 mol. % to about 40 mol. %, in some embodiments from about 10 mol. % to about 35 mol. %, and in some embodiments, from about 20 mol. % to about 30 mol. %; and/or aromatic diol(s) (e.g., BP and/or HQ) in an amount of from about 1 mol. % to about 40 mol. %, in some embodiments from about 10 mol. % to about 35 mol. %, and in some embodiments, from about 20 mol. % to about 30 mol. %.

Regardless of the particular constituents and nature of the polymer, the liquid crystalline polymer may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 250° C. to about 380° C., and in some embodiments, from about 280° C. to about 380° C. For instance, one suitable technique for forming the aromatic polyester may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 280° C. to about 380° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 250° C. to about 350° C. The polymerization time will of course vary based on the temperature and target molecular weight. In most cases, however, the solid-state polymerization time will be from about 2 to about 12 hours, and in some embodiments, from about 4 to about 10 hours.

### B. Carbon Black

As noted above, carbon black particles are also employed in the polymer composition and are distributed throughout the polymer matrix. The carbon black particles may constitute from about 0.1 wt. % to about 3 wt. %, in some embodiments from about 0.2 wt. % to about 2 wt. %, in some embodiments from about 0.4 wt. % to about 1.5 wt. %, in some embodiments from about 0.6 wt. % to about 1 wt. %, and in some embodiments, from about 1 wt. % to about 2 wt. % of the entire polymer composition.

Carbon black particles with relatively low conductivity are particularly suitable. Without intending to be limited by theory, it is believed that the use of carbon black particles with lower conductivity results in a composition having a lower dissipation factor. For example, the carbon black particles can have a surface resistivity of about 1×10² ohms or greater, in some embodiments about 1×10¹² ohms or greater, in some embodiments from about 1×10¹⁵ ohms to about 1×10¹⁸ ohms, and in some embodiments, from about 1×10¹⁶ ohms to about 1×10¹⁷ ohms. In some embodiments, when the carbon particles are contained in a liquid crystalline polymer masterbatch in an amount of 20 wt. %, the masterbatch can have a surface resistivity of about 1×10⁸ ohms or greater, in some embodiments about 1×10¹² ohms or greater, in some embodiments from about 1×10¹⁵ ohms to about 1×10¹⁸ ohms, and in some embodiments, from about 1×10¹⁶ ohms to about 1×10¹⁷ ohms. Similarly, when contained in a liquid crystalline polymer masterbatch in an amount of 50 wt. %, the masterbatch can have a surface resistivity of about 1×10² ohms or greater, in some embodiments about 1×10³ ohms or greater, in some embodiments from about 1×10⁴ ohms to about 1×10⁸ ohms, and in some embodiments, from about 1×10⁵ ohms to about 1×10⁶ ohms. Such masterbatches are described in more detail below.

Carbon black particles typically exist in the form of agglomerates of primary particles. In this regard, the carbon black particles have a primary particle size and a secondary particle size, where the primary particle size represents the smallest visibly distinct particles when viewed at a 20000-fold magnification level and the secondary particle size represents the particle size of the carbon black agglomerates, which are dispersed in the polymer matrix. In some embodiments, the carbon black particles have a number average primary particle size from about 5 nm to about 100 nm, in some embodiments from about 20 nm to about 70 nm, in some embodiments from about 30 nm to about 60 nm, and in some embodiments, from about 35 nm to about 45 nm. In some embodiments, the number average secondary particle size of the carbon black particles can be from about 1 μm to about 100 μm, in some embodiments from about 5 μm to about 50 μm, and in some embodiments from about 10 μm to about 30 μm. The number average primary and secondary particle sizes can be determined according to ASTM D3849-22.

The specific surface area of the carbon black particles is not particularly limited, but in some embodiments is from about 50 m²/g to about 1500 m²/g and in some embodiments from about 100 m²/g to about 1250 m²/g. The surface area can be determined by BET analysis, for example, according to ASTM D6556-21.

The pH of an aqueous dispersion of the carbon black particles at 25° C. can, in some embodiments, be from about 2.0 to about 8.5, in some embodiments from about 2.5 to about 7.5, and in some embodiments, from about 3.5 to about 6, The pH of a carbon black dispersion of pre-determined concentration can be measured with any suitably calibrated pH-meter equipment, for instance, according to ISO 787-9.

In some embodiments, the carbon black particles are selected from channel carbon black, furnace carbon black, lamp carbon black, and thermal carbon black. Preferably, the carbon black particles are not coated. Additionally, the carbon black particles preferably do not contain carbon nanotubes.

### C. Other Additives

A wide variety of additional additives can also be included in the polymer composition, such as lubricants, fibrous fillers, thermally conductive fillers, pigments, antioxidants, stabilizers, surfactants, waxes, flame retardants, anti-drip additives, nucleating agents (e.g., boron nitride), flow modifiers, coupling agents, antimicrobials, pigments or other colorants, impact modifiers, and other materials added to enhance properties and processability.

In one embodiment, for example, a fibrous filler may be employed in the polymer composition, such as in an amount from about 1 wt. % to about 40 wt. %, in some embodiments from about 3 wt. % to about 30 wt. %, in some embodiments from about 5 wt. % to about 20 wt. %, and in some embodiments, from about 7 wt. % to about 15 wt. % of the polymer composition. The fibrous filler typically includes fibers having a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments from about 3,000 MPa to about 6,000 MPa. To help maintain the desired dielectric properties, such high strength fibers may be formed from materials that are generally insulative in nature, such as glass, ceramics or minerals (e.g., alumina or silica), aramids (e.g., Kevlar® marketed by E. I. duPont de Nemours, Wilmington, Del.), minerals, polyolefins, polyesters, etc. The fibrous filler may include glass fibers, mineral fibers, or a mixture thereof. For instance, in one embodiment, the fibrous filler may include glass fibers. The glass fibers particularly suitable may include E-glass, A-glass, C-glass, D-glass, AR-glass, R-glass, S1-glass, S2-glass, etc. In another embodiment, the fibrous filler may include mineral fibers. The mineral fibers may include those derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are inosilicates, such as wollastonite fibers available from Nyco Minerals under the trade designation NYGLOS® (e.g., NYGLOS® 4 W or NYGLOS® 8).

Further, although the fibrous fillers may have a variety of different sizes, fibers having a certain aspect ratio can help improve the mechanical properties of the polymer composition. That is, fibrous fillers having an aspect ratio (average length divided by nominal diameter) of about 2 or more, in some embodiments from about 4 to about 50, in some embodiments from about 5 to about 20, and in some embodiments from about 6 to about 10 may be particularly beneficial. Such fibrous fillers may, for instance, have a weight average length from about 10 micrometers to about 800 micrometers, in some embodiments from about 25 micrometers to about 500 micrometers, in some embodiments from about 50 micrometers to about 300 micrometers, and in some embodiments, from about 60 micrometers to about 100 micrometers. Also, such fibrous fillers may, for instance, have a volume average length of about 10 micrometers to about 800 micrometers, in some embodiments from about 25 micrometers to about 500 micrometers, in some embodiments from about 50 micrometers to about 300 micrometers, and in some embodiments, from about 60 micrometers to about 100 micrometers. The fibrous fillers may likewise have a nominal diameter of about 5 micrometers or more, in some embodiments from about 6 micrometers to about 40 micrometers, in some embodiments from about 8 micrometers to about 20 micrometers, and in some embodiments from about 9 micrometers to about 12 micrometers. The relative amount of the fibrous filler may also be selectively controlled to help achieve the desired mechanical and thermal properties without adversely impacting other properties of the polymer composition, such as its flowability and dielectric properties, etc. In this regard, the fibrous fillers may have a dielectric constant of about 6 or less, in some embodiments about 5.5 or less, in some embodiments from about 1.1 to about 5, and in some embodiments from about 2 to about 4.8 at a frequency of 1 GHz.

The fibrous filler may be in a modified or an unmodified form, e.g., provided with a sizing, or chemically treated, in order to improve adhesion to the plastic. In some examples, glass fibers may be provided with a sizing to protect the glass fiber, to smooth the fiber but also to improve the adhesion between the fiber and a matrix material. If present, a sizing may comprise silanes, film forming agents, lubricants, wetting agents, adhesive agents optionally antistatic agents and plasticizers, emulsifiers and optionally further additives. In one particular embodiment, the sizing may include a silane. Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

If desired, the composition may also include a particulate filler. Particulate fillers may also be employed in the polymer composition as a dielectric filler to help achieve the desired properties and/or color. Particulate clay minerals may be particularly suitable for use in the present invention. Examples of such clay minerals include, for instance, talc (Mg₃Si₄O₁₀(OH₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂, (H₂O)]), montmorillonite (Na,Ca)_{0.33}(Al,Mg)₂Si₄O₁₀(OH)₂·nH₂O), vermiculite ((MgFe,Al)₃(Al,Si)₄O₁₀(OH)₂·4H₂O), palygorskite Mg,Al)₂Si₄O₁₀(OH)·4(H₂O)), pyrophyllite (Al₂Si₄O₁₀(OH)₂), etc., as well as combinations thereof. In lieu of, or in addition to, clay minerals, still other particulate fillers may also be employed. For example, other suitable particulate silicate fillers may also be employed, such as mica, diatomaceous earth, and so forth. Mica, for instance, may be a particularly suitable mineral for use in the present invention. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof. Other types of mineral particulate fillers may also be employed, such as silica, alumina, etc.

In some embodiments, it may also be desirable to use plate-like mineral particles, such as mica particles, having a relatively high aspect ratio (e.g., average diameter divided by average thickness), such as about 4 or greater, in some embodiments from about 10 to about 500, in some embodiments from about 30 to about 300, in some embodiments from about 50 to about 200, and in some embodiments, from about 70 to about 100. In such embodiments, the average diameter of the particles may range, for example, from about 5 microns to about 200 microns, in some embodiments from about 10 microns to about 100 microns, in some embodiments from about 15 microns to about 50 microns, and in some embodiments, from about 20 microns to about 30 microns. The average thickness, for example as determined using laser diffraction techniques in accordance with ISO 13320:2020 (e.g., using a Horiba LA-960 particle size distribution analyzer), may likewise be about 2 microns or less, in some embodiments from about 5 nanometers to about 1 micron, in some embodiments from about 10 nanometers to about 500 nanometers, in some embodiments from about 15 nanometers to about 100 nanometers, and in some embodiments, from about 20 nanometers to about 50 nanometers. The plate-like particles may also have a narrow size distribution. That is, at least about 70 vol % of the particles, in some embodiments at least about 80 vol % of the particles, and in some embodiments at least about 90 vol % of the particles may have a size within the ranges mentioned above.

In some embodiments, the polymer composition contains glass flakes. For example, glass flakes are scale-like glass particles typically having an average diameter from about 10 micrometers to about 4 millimeters and an average thickness from about 1 micrometer to about 7 micrometers. In some embodiments, the glass flakes are made of E-glass. The use of such glass flakes can provide the composition with good dimensional stability while maintaining its low dissipation factor.

To help achieve the desired dielectric properties, the polymer composition may also include hollow inorganic fillers. For instance, these fillers may have a dielectric constant of about 3.0 or less, in some embodiments about 2.5 or less, in some embodiments from about 1.1 to about 2.3, and in some embodiments from about 1.2 to about 2.0 at 100 MHz. In addition, the hollow inorganic fillers may have a certain size and contribute to the strength of the polymer composition while also allowing the polymer composition to have a reduced weight and/or density because of the hollow nature.

In general, the hollow inorganic fillers have an interior hollow space or cavity and may be synthesized using techniques known in the art. The hollow inorganic fillers may be made from conventional materials. For instance, the hollow inorganic fillers may include alumina, silica, zirconia, magnesia, glass, fly ash, borate, phosphate, ceramic, and the like. In one embodiment, the hollow inorganic fillers may include hollow glass fillers, hollow ceramic fillers, and mixtures thereof. In one embodiment, the hollow inorganic fillers include hollow glass fillers.

The hollow glass fillers may be made from a soda lime borosilicate glass, a soda lime glass, a borosilicate glass, a sodium borosilicate glass, a sodium silicate glass, or an aluminosilicate glass. In this regard, in one embodiment, the composition of the glass, while not limited, may be at least about 65% by weight of SiO₂, 3-15% by weight of Na₂O, 8-15% by weight of CaO, 0.1-5% by weight of MgO, 0.01-3% by weight of Al₂O₃, 0.01-1% by weight of K₂O, and optionally other oxides (e.g., Li₂O, Fe₂O₃, TiO₂, B₂O₃). In another embodiment, the composition may be about 50-58% by weight of SiO₂, 25-30% by weight of Al₂O₃, 6-10% by weight of CaO, 1-4% by weight of Na₂O/K₂O, and 1-5% by weight of other oxides. Also, in one embodiment, the hollow glass fillers may include more alkaline earth metal oxides than alkali metal oxides. For example, the weight ratio of the alkaline earth metal oxides to the alkali metal oxides may be more than 1, in some embodiments about 1.1 or more, in some embodiments about 1.2 to about 4, and in some embodiments from about 1.5 to about 3. Regardless of the above, it should be understood that the glass composition may vary depending on the type of glass utilized and still provide the benefits as desired by the present invention.

The hollow inorganic fillers may have at least one dimension having an average value that is about 1 micrometer or more, in some embodiments about 5 micrometers or more, in some embodiments about 8 micrometers or more, in some embodiments from about 1 micrometer to about 150 micrometers, in some embodiments from about 10 micrometers to about 150 micrometers, and in some embodiments from about 12 micrometers to about 50 micrometers. In one embodiment, such an average value may refer to a d₅₀ value.

Furthermore, the hollow inorganic fillers may have a D₁₀ of about 3 micrometers or more, in some embodiments about 4 micrometers or more, in some embodiments from about 5 micrometers to about 20 micrometers, and in some embodiments from about 6 micrometers to about 15 micrometers. The hollow inorganic fillers may have a D₉₀ of about 10 micrometers or more, in some embodiments about 15 micrometers or more, in some embodiments from about 20 micrometers to about 150 micrometers, and in some embodiments from about 22 micrometers to about 50 micrometers.

In this regard, the hollow inorganic fillers may be present in a size distribution, which may be a Gaussian, normal, or non-normal size distribution. In one embodiment, the hollow inorganic fillers may have a Gaussian size distribution. In another embodiment, the hollow inorganic fillers may have a normal size distribution. In a further embodiment, the hollow inorganic fillers may have a non-normal size distribution. Examples of non-normal size distributions may include unimodal and multi-modal (e.g., bimodal) size distributions.

When referring to dimensions above, such dimension may be any dimension. In one embodiment, however, such dimension refers to a diameter. For example, such value for the dimension refers to an average diameter of spheres. The dimension, such as the average diameter, may be determined in accordance to 3M QCM 193.0. In this regard, in one embodiment, the hollow inorganic fillers may be referring to hollow spheres such as hollow glass spheres. For instance, the hollow inorganic fillers may have an average aspect ratio of approximately 1. In general, the average aspect ratio may be about 0.8 or more, in some embodiments about 0.85 or more, in some embodiments from about 0.9 to about 1.3, and in some embodiments from about 0.95 to about 1.05.

In addition, the hollow inorganic fillers may have relatively thin walls to help with the dielectric properties of the polymer composition as well as the reduction in weight. The thickness of the wall may be about 50% or less, in some embodiments about 40% or less, in some embodiments from about 1% to about 30%, and in some embodiments from about 2% to about 25% the average dimension, such as the average diameter, of the hollow inorganic fillers.

In addition, the hollow inorganic fillers may have a certain true density that can allow for easy handling and provide a polymer composition having a reduction in weight. In general, the true density refers to the quotient obtained by dividing the mass of a sample of the hollow fillers by the true volume of that mass of hollow fillers wherein the true volume is referred to as the aggregate total volume of the hollow fillers. In this regard, the true density of the hollow inorganic fillers may be about 0.1 g/cm³ or more, in some embodiments about 0.2 g/cm³ or more, in some embodiments from about 0.3 g/cm³ or more to about 1.2 g/cm³, and in some embodiments from about 0.4 g/cm³ or more to about 0.9 g/cm³. The true density may be determined in accordance to 3M QCM 14.24.1.

Even though the fillers are hollow, they may have a mechanical strength that allows for maintaining the integrity of the structure of the fillers resulting in a lower likelihood of the fillers being broken during processing and/or use. In this regard, the isotactic crush resistance (i.e., wherein at least 80 vol. %, such as at least 90 vol. % of the hollow fillers survive) of the hollow inorganic fillers may be about 20 MPa or more, in some embodiments about 100 MPa or more, in some embodiments from about 150 MPa to about 500 MPa, and in some embodiments from about 200 MPa to about 350 MPa. The isotactic crush resistance may be determined in accordance to 3M QCM 14.1.8.

The alkalinity of the hollow inorganic fillers may be about 1.0 meq/g or less, in some embodiments about 0.9 meq/g or less, in some embodiments from about 0.1 meq/g to about 0.8 meq/g, and in some embodiments from about 0.2 meq/g to about 0.7 meq/g. The alkalinity may be determined in accordance to 3M QCM 55.19. In order to provide a relatively low alkalinity, the hollow inorganic fillers may be treated with a suitable acid, such as a phosphoric acid.

In addition, the hollow inorganic fillers may also include a surface treatment to assist with providing a better compatibility with the polymer and/or other components within the polymer composition. As an example, the surface treatment may be a silanization. In particular, the surface treatment agents may include, but are not limited to, aminosilanes, epoxysilanes, and the like.

When employed, the hollow inorganic fillers may, for instance, constitute about 1 wt. % or more, in some embodiments about 4 wt. % or more, in some embodiments from about 5 wt. % to about 40 wt. %, and in some embodiments from about 10 wt. % to about 30 wt. % of the polymer composition. Furthermore, to provide beneficial properties, the weight ratio of polymer to the hollow inorganic filler may be about 0.1 or more, in some embodiments about 1 or more, in some embodiments about 1.5 or more, in some embodiments from about 0.1 to about 10, in some embodiments from about 1 to about 10, in some embodiments from about 2 to about 10, in some embodiments from about 2 to about 6, and in some embodiments from about 2 to about 5. However, in other embodiments, the composition achieves the desired dielectric properties without the use of any hollow fillers.

In some embodiments, the composition can contain a combination of a fibrous filler and a plate-like mineral filler. For instance, in some embodiments the composition contains a filler comprising a combination of milled glass fibers and mica. In such embodiments, the ratio of plate-like mineral filler to fibrous filler may be from about 0.1 to about 20, in some embodiments from about 0.5 to about 10, in some embodiments from about 1 to about 5, and in some embodiments, from about 2 to about 3.

### II. Formation

The components used to form the polymer composition may be combined together using any of a variety of different techniques as is known in the art. In one particular embodiment, for example, the liquid crystalline polymer, carbon black, and other optional additives are melt processed as a mixture within an extruder to form the polymer composition. The mixture may be melt-kneaded in a single-screw or multi-screw extruder at a temperature of from about 200° C. to about 450° C. In one embodiment, the mixture may be melt processed in an extruder that includes multiple temperature zones. The temperature of individual zones are typically set within about −60° C. to about 25° C. relative to the melting temperature of the polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the polymer may be applied at the feed throat, and certain additives (e.g., carbon black particles and/or other additives) may be supplied at the same or different temperature zone located downstream therefrom. Regardless, the resulting mixture can be melted and mixed then extruded through a die. The extruded polymer composition can then be quenched in a water bath to solidify and be granulated in a pelletizer followed by drying.

In some embodiments, the carbon black particles are added to the composition in the form of a masterbatch. The masterbatch, for example, may comprise a relatively high concentration of carbon black in a thermoplastic carrier. In some embodiments, carbon black particles constitute from about 5 wt. % to about 70 wt. %, in some embodiments from about 15 wt. % to about 60 wt. %, and in some embodiments, from about 20 wt. % to about 50 wt. % of the masterbatch. Preferably the thermoplastic carrier comprises a liquid crystalline polymer, which may be the same or different from the liquid crystalline polymer matrix. The masterbatch may be blended with the polymer matrix and any optional fillers in an extruder as described above.

Regardless of the manner in which the components are incorporated into the composition, the resulting melt viscosity is generally low enough that it can readily flow into the cavity of a mold to form a small-sized circuit substrate. For example, in one particular embodiment, the polymer composition may have a melt viscosity of from about 5 Pa-s or more, in some embodiments about 10 Pa-s or more, in some embodiments from about 10 Pa-s to about 500 Pa-s, in some embodiments from about 5 Pa-s to about 150 Pa-s, in some embodiments from about 5 Pa-s to about 100 Pa-s, in some embodiments from about 10 Pa-s to about 100 Pa-s, in some embodiments from about 15 to about 90 Pa-s, as determined at a shear rate of 1,000 seconds⁻¹.

### III. Applications

In some embodiments, the polymer composition can be formed into a film. Any of a variety of different techniques may generally be used to form the polymer composition into a film. Suitable techniques may include, for instance, solvent casting, melt extrusion (e.g., die casting, blown film casting, extrusion coating, etc.), and so forth. In one particular embodiment, a blown film process is employed in which the composition is fed to an extruder, where it is melt processed and then supplied through a blown film die to form a molten bubble. Typically, the die contains a mandrel that is positioned within the interior of an outer die body so that a space is defined therebetween. The polymer composition is blown through this space to form the bubble, which can then be drawn, inflated with air, and rapidly cooled so that the polymer composition quickly solidifies. If desired, the bubble may then be collapsed between rollers and optionally wound onto a reel. The thickness of the resulting film may vary, but is typically about 500 micrometers or less, in some embodiments from about 1 to about 250 micrometers, in some embodiments from about 2 to about 100 micrometers, and in some embodiments, from about 5 to about 50 micrometers.

In some embodiments, the film can be used as a layer in a laminate. For example, the film can be positioned adjacent to at least one conductive layer to form the laminate. The conductive layer may be provided in a variety of different forms, such as membranes, films, molds, wafers, tubes, etc. For example, the layer may have a foil-like structure in that it is relatively thin, such as having a thickness of about 500 micrometers or less, in some embodiments about 200 micrometers or less, and in some embodiments, from about 1 to about 100 micrometers. Of course, higher thicknesses may also be employed. The conductive layer may also contain a variety of conductive materials, such as a metal, e.g. gold, silver, nickel, aluminum, copper, as well as mixture or alloys thereof. In one embodiment, for instance, the conductive layer may include copper (e.g., pure copper and copper alloys).

The film may be applied to the conductive layer using techniques such as described above (e.g., casting), or the conductive layer may alternatively be applied to the film using techniques such as ion beam sputtering, high frequency sputtering, direct current magnetron sputtering, glow discharge, etc. If desired, the film may be subjected to a surface treatment on a side facing the conductive layer so that the adhesiveness between the film and conductive layer is improved. Examples of such surface treatments include, for instance, corona discharge treatment, UV irradiation treatment, plasma treatment, etc. When applied to a conductive layer, the film may be optionally annealed to improve its properties. For example, annealing may occur at a temperature of from about 250° C. to about 400° C., in some embodiments from about 260° C. to about 350° C., and in some embodiments, from about 280° C. to about 330° C., and for a time period ranging from about 15 minutes to about 300 minutes, in some embodiments from about 20 minutes to about 200 minutes, and in some embodiments, from about 30 minutes to about 120 minutes. During annealing, it is sometimes desirable to restrain the film at one or more locations (e.g., edges) so that it is not generally capable of physical movement. This may be accomplished in a variety of ways, such as by clamping, taping, or otherwise adhering the film to the conductive layer.

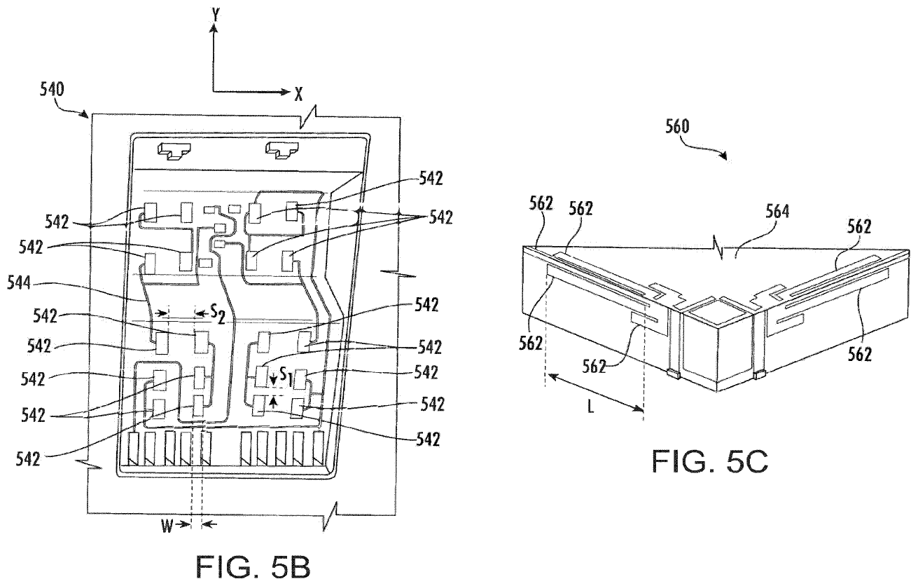

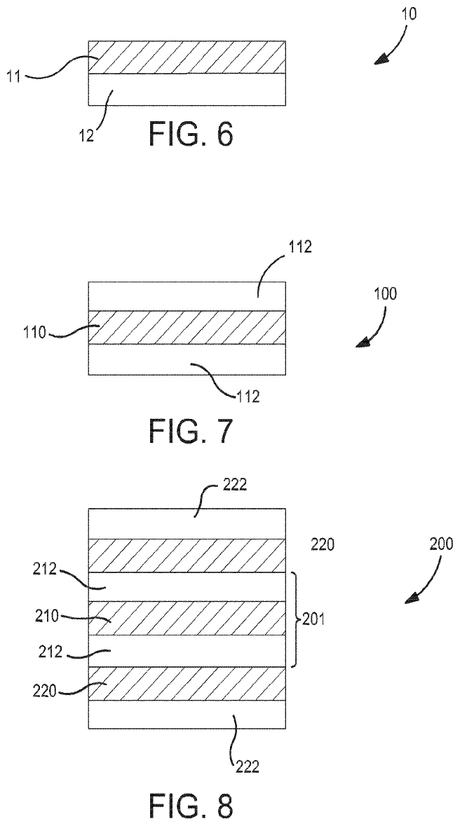

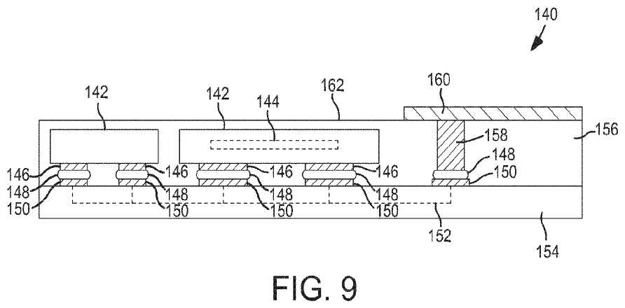

The laminate may have a two-layer structure containing only the film and conductive layer. Referring to FIG. 6, for example, one embodiment of such a two layer structure 10 is shown as containing a film 11 positioned adjacent to a conductive layer 12 (e.g., copper foil). Alternatively, a multi-layered laminate may be formed that contains two or more conductive layers and/or two or more films. Referring to FIG. 7, for example, one embodiment of a three-layer laminate structure 100 is shown that contains a film 110 positioned between two conductive layers 112. Yet another embodiment is shown in FIG. 8. In this embodiment, a seven-layered laminate structure 200 is shown that contains a core 201 formed from a film 210 positioned between two conductive layers 212. Films 220 likewise overlie each of the conductive layers 212, respectively, and external conductive layers 222 overlie the films 220. In the embodiments described above, the film of the present invention may be used to form any, or even all of the film layers. Various conventional processing steps may be employed to provide the laminate with sufficient strength. For example, the laminate may be pressed and/or subjected to heat treatment as is known in the art.

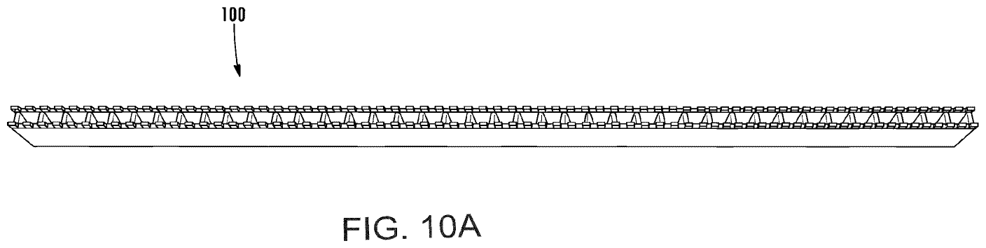

The laminate of the present invention may be employed in a wide variety of different applications. For example, as noted above, the laminate may be employed in a circuit board (e.g., printed circuit board) of an electronic device that is provided with antenna elements. The antenna elements may be applied (e.g., printed) directly onto the circuit board, or alternatively they may be provided in an antenna module that is supported by and connected to the circuit board. Referring to FIG. 9, for instance, one embodiment of an electronic device 140 is shown that contains a substrate 154 that supports various electrical components 142, such as integrated circuits (e.g., transceiver circuitry, control circuitry, etc.), discrete components (e.g., capacitors, inductors, resistors), switches, and so forth. An encapsulant material 156 may be applied over the components 142 and a printed circuit board 154, such as described herein, that contains conductive traces 152 and contact pads 150 for forming electrical signal paths. A semiconductor die 144 may also be employed that is bonded to the printed circuit board and embedded within the package body to form each respective component 142. More particularly, the components 142 may have contacts 146 (e.g., solder pads) and may be mounted to contacts 150 on the printed circuit board 154 using a conductive material 148 (e.g., solder) coupled between contacts 146 and contacts 150. In the illustrated embodiment, antenna elements 160 are formed on an exposed surface of the encapsulant material 156. The antenna elements 156 may be electrically connected to the printed circuit board 154 via a transmission line 158 (e.g. metal post).

In certain embodiments, the printed circuit board is specifically configured for use in a 5G antenna system. As used herein, “5G” generally refers to high speed data communication over radio frequency signals. 5G networks and systems are capable of communicating data at much faster rates than previous generations of data communication standards (e.g., “4G, “LTE”). Various standards and specifications have been released quantifying the requirements of 5G communications. As one example, the International Telecommunications Union (ITU) released the International Mobile Telecommunications-2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a 5G system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHZ frequencies and “Frequency Range 2” (FR2) as frequency bands ranging from 20-60 GHz. However, as used herein “5G frequencies” can refer to systems utilizing frequencies greater than 60 GHz, for example ranging up to 80 GHZ, up to 150 GHz, and up to 300 GHz. As used herein, “5G frequencies” can refer to frequencies that are about 2.5 GHz or higher, in some embodiments about 3.0 GHz or higher, in some embodiments from about 3 GHz to about 300 GHZ, or higher, in some embodiments from about 4 GHz to about 80 GHZ, in some embodiments from about 5 GHz to about 80 GHZ, in some embodiments from about 20 GHz to about 80 GHz, and in some embodiments from about 28 GHz to about 60 GHz.

5G antenna systems generally employ high frequency antennas and antenna arrays for use in base stations, repeaters (e.g., “femtocells”), relay stations, terminals, user devices, and/or other suitable components of 5G systems. The antenna elements/arrays and systems can satisfy or qualify as “5G” under standards released by 3GPP, such as Release 15 (2018), and/or the IMT-2020 Standard. To achieve such high speed data communication at high frequencies, antenna elements and arrays generally employ small feature sizes/spacing (e.g., fine pitch technology) and/or advanced materials that can improve antenna performance. For example, the feature size (spacing between antenna elements, width of antenna elements) etc. is generally dependent on the wavelength (“A”) of the desired transmission and/or reception radio frequency propagating through the circuit board on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO). The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, etc. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater.

The antenna elements may be fabricated using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may also be employed. As a result of such small feature dimensions, antenna configurations and/or arrays can be achieved with a large number of antenna elements in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

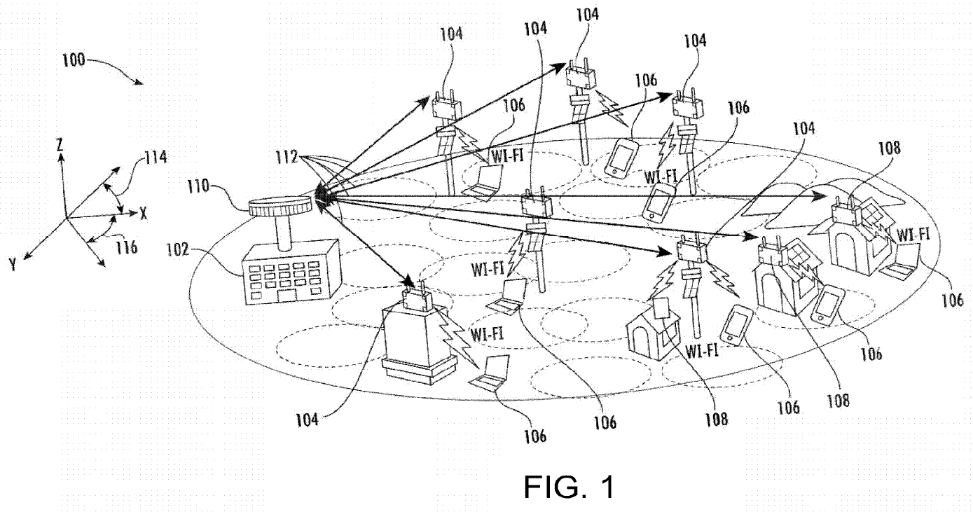

Referring to FIG. 1, for example, a 5G antenna system 100 can include a base station 102, one or more relay stations 104, one or more user computing devices 106, one or more Wi-Fi repeaters 108 (e.g., “femtocells”), and/or other suitable antenna components for the 5G antenna system 100. The relay stations 104 can be configured to facilitate communication with the base station 102 by the user computing devices 106 and/or other relay stations 104 by relaying or “repeating” signals between the base station 102 and the user computing devices 106 and/or relay stations 104. The base station 102 can include a MIMO antenna array 110 configured to receive and/or transmit radio frequency signals 112 with the relay station(s) 104, Wi-Fi repeaters 108, and/or directly with the user computing device(s) 106. The user computing device 306 is not necessarily limited by the present invention and can include devices such as 5G smartphones.

The MIMO antenna array 110 can employ beam steering to focus or direct radio frequency signals 112 with respect to the relay stations 104. For example, the MIMO antenna array 110 can be configured to adjust an elevation angle 114 with respect to an X-Y plane and/or a heading angle 116 defined in the Z-Y plane and with respect to the Z direction. Similarly, one or more of the relay stations 104, user computing devices 106, Wi-Fi repeaters 108 can employ beam steering to improve reception and/or transmission ability with respect to MIMO antenna array 110 by directionally tuning sensitivity and/or power transmission of the device 104, 106, 108 with respect to the MIMO antenna array 110 of the base station 102 (e.g., by adjusting one or both of a relative elevation angle and/or relative azimuth angle of the respective devices).

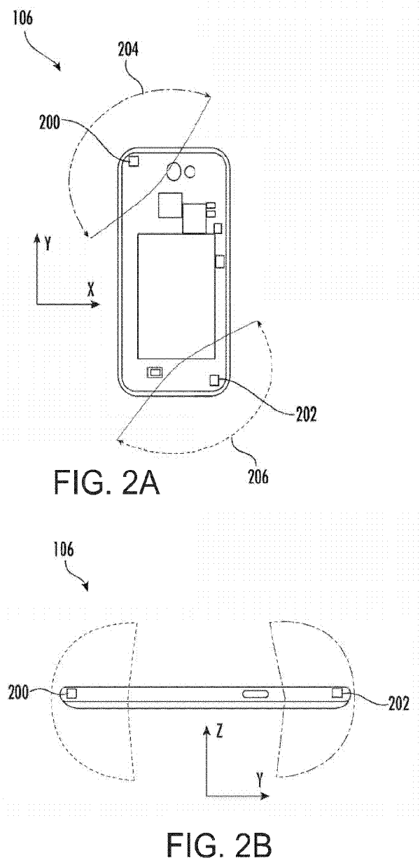

FIGS. 2A-2B likewise illustrate a top-down and side elevation view, respectively, of an example user computing device 106. The user computing device 106 may include one or more antenna elements 200, 202 (e.g., arranged as respective antenna arrays). Referring to FIG. 2A, the antenna elements 200, 202 can be configured to perform beam steering in the X-Y plane (as illustrated by arrows 204, 206 and corresponding with a relative azimuth angle). Referring to FIG. 2B, the antenna elements 200, 202 can be configured to perform beam steering in the Z-Y plane (as illustrated by arrows 204, 206).

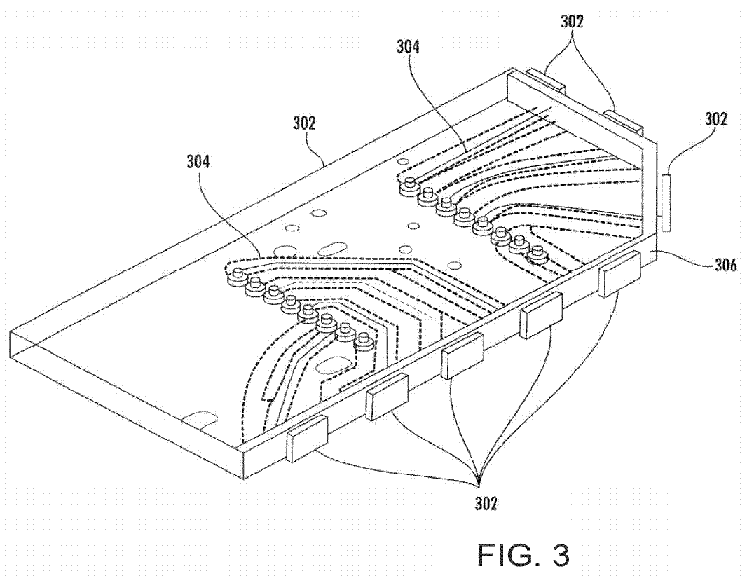

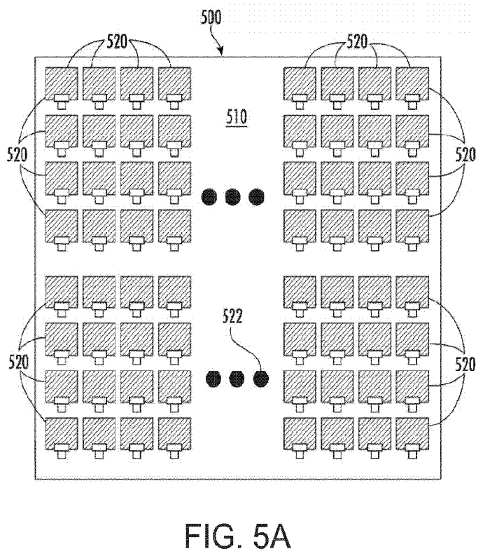

FIG. 3 depicts a simplified schematic view of a plurality of antenna arrays 302 connected using respective feed lines 304 (e.g., with a front-end module). The antenna arrays 302 can be mounted to a side surface 306 of the substrate 308, for example as described and illustrated with respect to FIGS. 5A through 5C. The substrate 308 may, for example, be a circuit board such as described herein. The antenna arrays 302 can include a plurality of vertically connected elements (e.g., as a mesh-grid array). Thus, the antenna array 302 can generally extend parallel with the side surface 306 of the substrate 308. Shielding can optionally be provided on the side surface 306 of the substrate 308 such that the antenna arrays 302 are located outside of the shielding with respect to the substrate 308. The vertical spacing distance between the vertically connected elements of the antenna array 302 can correspond with the “feature sizes” of the antenna arrays 320. As such, in some embodiments, these spacing distances may be relatively small (e.g., less than about 750 micrometers) such that the antenna array 302 is a “fine pitch” antenna array 302.

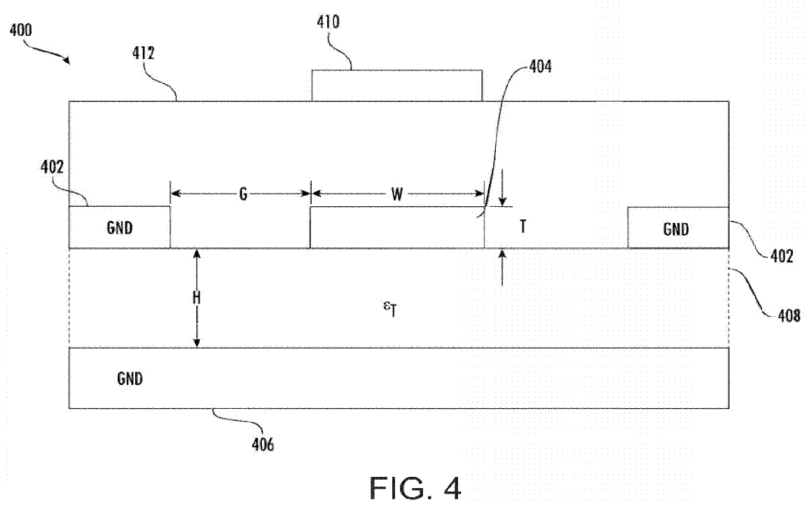

FIG. 4 illustrates a side elevation view of a co-planar waveguide antenna 400 configuration. One or more co-planar ground layers 402 can be arranged parallel with an antenna element 404 (e.g., a patch antenna element). Another ground layer 406 may be spaced apart from the antenna element by a substrate 408, which may be a circuit board such as described herein. One or more additional antenna elements 410 can be spaced apart from the antenna element 404 by a second layer or substrate 412, which may be a circuit board as described herein. The dimensions “G” and “W” may correspond with “feature sizes” of the antenna 400. The “G” dimension may correspond with a distance between the antenna element 404 and the co-planar ground layer(s) 406. The “W” dimension can correspond with a width (e.g., linewidth) of the antenna element 404. As such, in some embodiments, dimensions “G” and “W” may be relatively small (e.g., less than about 750 micrometers) such that the antenna 400 is a “fine pitch” antenna 400.

FIG. 5A illustrates one embodiment of an antenna array 500. The antenna array 500 can include a substrate 510 and a plurality of antenna elements 520 formed thereon. The substrate 510 may, for example, be a circuit board such as described herein. The plurality of antenna elements 520 can be approximately equally sized in the X- and/or Y-directions (e.g., square or rectangular). The plurality of antenna elements 520 can be spaced apart approximately equally in the X- and/or Y-directions. The dimensions of the antenna elements 520 and/or spacing therebetween can correspond with “feature sizes” of the antenna array 500. As such, in some embodiments, the dimensions and/or spacing may be relatively small (e.g., less than about 750 micrometers) such that the antenna array 500 is a “fine pitch” antenna array 500. As illustrated by the ellipses 522, the number of columns of antenna elements 520 illustrated in FIG. 5A is provided as an example only. Similarly, the number of rows of antenna element 520 is provided as an example only.

The tuned antenna array 500 can be used to provide massive MIMO functionality, for example in a base station (e.g., as described above with respect to FIG. 1). More specifically, radio frequency interactions between the various elements can be controlled or tuned to provide multiple transmitting and/or receiving channels. Transmitting power and/or receiving sensitivity can be directionally controlled to focus or direct radio frequency signals, for example as described with respect to the radio frequency signals 112 of FIG. 1. The tuned antenna array 500 can provide a large number of antenna elements 522 in a small footprint. For example, the tuned antenna 500 can have an average antenna element concentration of 1,000 antenna elements per square cm or greater. Such compact arrangement of antenna elements can provide a greater number of channels for MIMO functionality per unit area. For example, the number of channels can correspond with (e.g., be equal to or proportional with) the number of antenna elements.

FIG. 5B illustrates an embodiment of an antenna array 540. The antenna array 540 can include a plurality of antenna elements 542 and plurality of feed lines 544 connecting the antenna elements 542 (e.g., with other antenna elements 542, a front-end module, or other suitable component). The antenna elements 542 can have respective widths “w” and spacing distances “S₁” and “S₂” therebetween (e.g., in the X-direction and Y-direction, respectively). These dimensions can be selected to achieve 5G radio frequency communication at a desired 5G frequency. More specifically, the dimensions can be selected to tune the antenna array 540 for transmission and/or reception of data using radio frequency signals that are within the 5G frequency spectrum (e.g., greater the 2.5 GHZ and/or greater than 3 GHZ and/or greater than 28 GHZ). The dimensions can be selected based on the material properties of the substrate. For example, one or more of “w”, “S₁,” or “S₂” can correspond with a multiple of a propagation wavelength (“λ”) of the desired frequency through the substrate material (e.g., nλ/4 where n is an integer).

As one example, A can be calculated as follows:

$$λ = \frac{c}{f \sqrt{{ϵ}_{R}}}$$

where c is the speed of light in a vacuum, ∈_{R} is the dielectric constant of the substrate (or surrounding material), f is the desired frequency.

FIG. 5C illustrates an example antenna configuration 560 according to aspects of the present invention. The antenna configuration 560 can include multiple antenna elements 562 arranged in parallel long edges of a substrate 564. The various antenna elements 562 can have respective lengths, “L” (and spacing distances therebetween) that tune the antenna configuration 560 for reception and/or transmission at a desired frequency and/or frequency range. More specifically, such dimensions can be selected based on a propagation wavelength, A, at the desired frequency for the substrate material, for example as described above with reference to FIG. 5B.

As noted above, the wireless-communications-tower component can be an RF filter. An RF filter is a key element in a remote radio head. RF filters are used to eliminate signals of certain frequencies and are commonly used as building blocks for duplexers and diplexers to combine or separate multiple frequency bands. RF filters also play a key role in minimizing interference between systems operating in different bands. An RF cavity filter is a commonly used RF filter. A common practice to make these filters of various designs and physical geometries is to die cast aluminum into the desired structure or machine a final geometry from a pre-form. RF filters, their characteristics, their usage, their fabrication, their machining, and their overall production are described, for example, in U.S. Pat. Nos. 7,847,658 and 8,072,298.

In various embodiments, at least a portion of the above-described polymer composite can be metal plated (i.e., metalized), as is typically done for RF cavity filters. For example, a metal layer such as copper, silver, or gold can be deposited on the polymer composite via various plating techniques. Examples of suitable plating techniques can be found, for example, in U.S. Provisional Patent Application Ser. No. 61/577,918.

In other embodiments, the polymer composition may be molded into a desired shape for a particular application. Typically, the shaped parts are molded using a one-component injection molding process in which dried and preheated plastic granules are injected into the mold. In one embodiment, the molded part or shape may be an electrical connector as mentioned above. The electrical connector may find particular application with 5G radio frequency systems. For example, the electrical connector can communicatively couple any of the devices described in the 5G system described above, such as the antennas and/or antenna arrays with the one or more integrated circuits, processors, memory, etc.

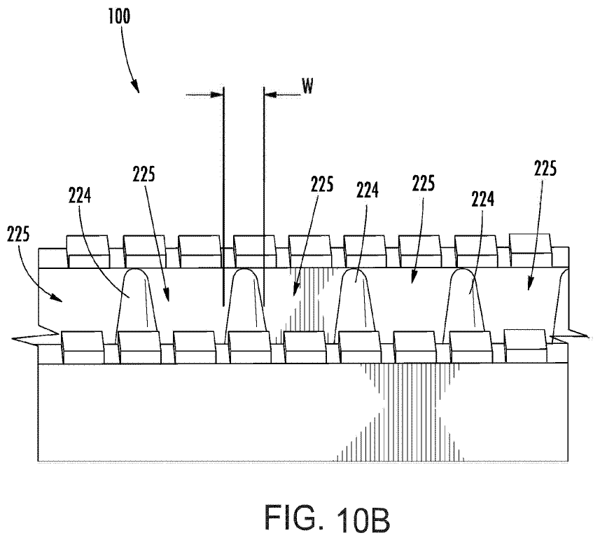

One particularly suitable electrical connector 100 is shown in FIG. 10A according to aspects of the present invention. FIG. 10B depicts an enlarged view of the electrical connector 100 of FIG. 10A. As illustrated, insertion passageways or spaces 225 are defined between opposing walls 224 that can accommodate contact pins to facilitate a large number of distinct electrical connections. The electrical connector 100 can be very compact. More specifically, the walls 224 can have respective widths “w” that are relatively thin, such as within the ranges described above.

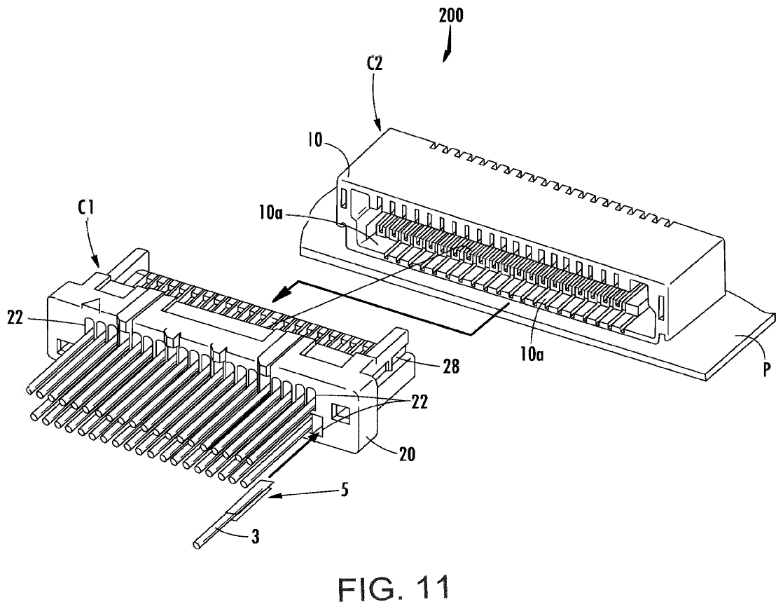

Another embodiment of an electrical connector 200 is depicted in FIG. 11. A board-side portion C2 that can be mounted onto the surface of a circuit board P. The connector 200 may also include a wiring material-side portion C1 structured to connect discrete wires 3 to the circuit board P by being coupled to the board-side connector C2. The board-side portion C2 may include a first housing 10 that has a fitting recess 10a into which the wiring material-side connector C1 is fitted and a configuration that is slim and long in the widthwise direction of the housing 10. The wiring material-side portion C1 may likewise include a second housing 20 that is slim and long in the widthwise direction of the housing 20. In the second housing 20, a plurality of terminal-receiving cavities 22 may be provided in parallel in the widthwise direction so as to create a two-tier array including upper and lower terminal-receiving cavities 22. A terminal 5, which is mounted to the distal end of a discrete wire 3, may be received within each of the terminal-receiving cavities 22. If desired, locking portions 28 (engaging portions) may also be provided on the housing 20 that correspond to a connection member (not shown) on the board-side connector C2.

As discussed above, the interior walls of the first housing 10 and/or second housing 20 may be relatively thin (e.g., may have a relatively small width dimension), and can be formed from the polymer composition of the present invention.

The electrical connector may reduce or prevent interference (e.g., “cross-talk”) between signals that are transmitted on adjacent or nearby pins because of the dielectric properties of the polymer composition from which it is formed.

The present invention may be better understood with reference to the following examples.

### Test Methods

Melt Viscosity: The melt viscosity (Pa-s) may be determined in accordance with ISO Test No. 11443:20021 at a shear rate of 1,000 s⁻¹ and temperature 15° C. above the melting temperature (e.g., about 350° C.) using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO Test No. 75-2:2013 (technically equivalent to ASTM D648-18). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-17). This test may be performed on a 64 mm support span. Tests may be run on the center portions of uncut ISO 3167 multi-purpose bars. The testing temperature may be 23° C. and the testing speed may be 2 mm/min.

Unnotched and Notched Charpy Impact Strength: Charpy properties may be tested according to ISO Test No. ISO 179-1:2010) (technically equivalent to ASTM D6110-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Dielectric Constant (“Dk”) and Dissipation Factor (“Df”): The dielectric constant (or relative static permittivity) and dissipation factor are determined using a known split-post dielectric resonator technique, such as described in Baker-Jarvis, et al., IEEE Trans. on Dielectric and Electrical Insulation, 5(4), p. 571 (1998) and Krupka, et al., Proc. 7^{th} International Conference on Dielectric Materials: Measurements and Applications, IEEE Conference Publication No. 430 (September 1996). More particularly, a plaque sample having a size of 80 mm×80 mm×1 mm was inserted between two fixed dielectric resonators. The resonator measured the permittivity component in the plane of the specimen. Five (5) samples are tested and the average value is recorded. The split-post resonator can be used to make dielectric measurements in the low gigahertz region, such as 1 GHz from 2 GHz.

Surface/Volume Resistivity: The surface and volume resistivity values are generally determined in accordance with IEC 60093 (similar to ASTM D257-14). According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square. Volume resistivity is also determined as the ratio of the potential gradient parallel to the current in a material to the current density. In SI units, volume resistivity is numerically equal to the direct-current resistance between opposite faces of a one-meter cube of the material (ohm-m).

CIELAB Test for Lightness (L*): Color measurement is performed using a DataColor 600 Spectrophotometer utilizing an integrating sphere with measurements made using the specular included mode. Color coordinates are calculated according to ASTM D2244-11 under an illuminant D65/10°, A/10°, or F2/10° observer, using CIELAB units.

### Example 1

Sample 1 was prepared by blending 40 parts carbon black masterbatch including 50 wt. % carbon black particles in a liquid crystalline polymer carrier with 60 parts of neat liquid crystalline polymer resin (LCP 1) using a cube blending method. As such, the blended resin had a carbon black content of 20 wt. %. The surface resistivity of the 50 wt. % carbon black masterbatch was measured to be 7.7×10⁵ ohms. The carbon black particles in the masterbatch were measured to have a number average primary particle size of 41 nm and a number average secondary particle size of 22 μm. Sample 2 is a carbon black masterbatch containing 20 wt. % carbon black particles and 80 wt. % of LCP 2. LCP 1 was formed from 43.86 mol. % HBA, 8.57 mol. % TA, 28.57 mol. % HQ, and 20 mol. % NDA. LCP 2 was formed from 2 mol. % HBA, 48 mol. % HNA, 25 mol. % BP, and 25 mol. % TA. LCP 2 had a melting temperature of 350° C. The surface resistivities of Samples 1 and 2 were measured and are provided in Table 1.

TABLE 1

| | | Surface |
|---|---|---|
| Sample | Molding | Resistivity (ohms) |
| CB masterbatch (50 | 4 inch disc with 3 mm thickness | 7.7 × 10⁵ |
| wt. % carbon black) | | |
| Sample 1 | 4 inch disc with 3 mm thickness | 3.0 × 10¹⁶ |
| Sample 2 | 4 inch disc with 3 mm thickness | 1.3 × 10⁶ |

### Example 2

Samples 3-10 are formed from liquid crystalline polymers (LCP 1 or LCP 2), mica, glass powder, glass fibers, lubricant, and carbon black in the amounts shown in Table 2. The glass powder consists of milled fibers having a weight-average fiber length of 70 μm and a nominal diameter of 10 μm. The mica consists of plate-like particles having an average particle diameter of 24 μm and an average aspect ratio of 80. Further, the glass fibers employed had an initial length of either 3 mm or 4 mm. The carbon black used in Samples 3-9 (CB MB 1) is from the 50 wt. % masterbatch used in Sample 1. The carbon black used in Sample 10 (CB MB 2) is from Sample 2 containing 20 wt. % carbon black. The dielectric properties of Samples 3-10 were measured, as shown in Table 2.

TABLE 2

| Sample | 3 | 4 | 5 | 6 | 7 | 8 | 9 | 10 |
|---|---|---|---|---|---|---|---|---|
| LCP 1 [wt. %] | 82.075 | 82.075 | 79.575 | — | — | — | — | — |
| LCP 2 [wt. %] | — | — | — | 79.2 | 78.4 | 80 | 66 | 61 |
| CB MB 1 [wt. %] | 2.5 | 2.5 | — | 0.8 | 1.6 | — | 2 | — |
| CB MB 2 [wt. %] | — | — | — | — | — | — | — | 5 |
| Glass powder [wt. %] | — | — | — | — | — | — | 10 | 10 |
| Glass fibers [wt. %] | 15 | 15 | 15 | — | — | — | — | — |
| Mica [wt. %] | — | — | — | 20 | 20 | 20 | 22 | 22 |
| Lubricant [wt. %] | 0.2 | 0.2 | 0.2 | — | — | — | — | — |
| Modifier [wt. %] | 0.225 | 0.225 | 0.225 | — | — | — | — | — |
| Dk at 10 GHz | 3.74 | 3.74 | 3.53 | 3.89 | 3.98 | 3.82 | 4.19 | 4.36 |
| Df at 10 GHz | 0.0034 | 0.0037 | 0.0029 | 0.0008 | 0.0009 | 0.0007 | 0.0016 | 0.0029 |
| Lightness [L*] | — | — | — | 53.09 | 47.43 | — | 45.8 | 44.7 |
| Melt Viscosity (1000 s⁻¹) [Pa-s] | — | — | — | 21.3 | 21.0 | 20.2 | 18.8 | 21.5 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising a liquid crystalline polymer matrix and carbon black particles dispersed within the polymer matrix, the carbon black particles constituting from about 0.1 wt. % to about 3 wt. % of the composition, the composition exhibiting a dissipation factor less than 0.002 when measured at a frequency of 10 GHz and a lightness (L*) of about 60 or less.

2. The polymer composition of claim 1, wherein the carbon black particles have a number average primary particle size from about 20 to about 60 nm as determined according to ASTM D₃₈₄₉-22.

3. The polymer composition of claim 1, wherein the carbon black particle have a number-average aggregate particle size from about 5 μm to about 50 μm as determined according to ASTM D₃₈₄₉-22.

4. The polymer composition of claim 1, further comprising a filler in an amount from about 5 wt. % to about 50 wt. % of the composition.

5. The polymer composition of claim 4, wherein the filler comprises a fibrous filler.

6. The polymer composition of claim 5, wherein the fibrous filler includes glass fibers.

7. The polymer composition of claim 6, wherein the glass fibers have an average length from about 30 μm to about 150 μm.

8. The polymer composition of claim 6, wherein the glass fibers have an aspect ratio from about 3 to about 15.

9. The polymer composition of claim 4, wherein the filler comprises a plate-like filler.

10. The polymer composition of claim 9, wherein the plate-like filler includes mica.

11. The polymer composition of claim 10, wherein the mica has an average particle size from about 10 μm to about 50 μm.

12. The polymer composition of claim 10, wherein the mica has an average thickness from about 0.1 μm to about 1 μm.

13. The polymer composition of claim 1, wherein a masterbatch consisting of 20 wt. % of the carbon particles and 80 wt. % of the liquid crystalline polymer resin exhibits a surface resistivity greater than 1×10¹⁵ ohms as determined according to ASTM D257-14.

14. The polymer composition of claim 1, wherein the composition exhibits a lightness (L*) greater than 30.

15. The polymer composition of claim 1, wherein the composition exhibits a lightness (L*) greater than 40.

16. The polymer composition of claim 1, wherein the composition exhibits a lightness (L*) greater than 45.

17. The polymer composition of claim 1, wherein the composition exhibits a dissipation factor less than 0.001 when measured at a frequency of 10 GHz.

18. The polymer composition of claim 1, wherein the liquid crystalline polymer contains repeating units derived from one or more aromatic dicarboxylic acids, one or more aromatic hydroxycarboxylic acids, or a combination thereof.

19. The polymer composition of claim 18, wherein the aromatic hydroxycarboxylic acids include 4-hydroxybenzoic acid, 6-hydroxy-2-naphthoic acid, or a combination thereof.

20. The polymer composition of claim 18, wherein the aromatic hydroxycarboxylic acids include terephthalic acid, isophthalic acid, 2,6-naphthalenedicarboxylic acid, or a combination thereof.

21. The polymer composition of claim 18, wherein the liquid crystalline polymer further contains repeating units derived from one or more aromatic diols.

22. The polymer composition of claim 21, wherein the aromatic diols include hydroquinone, 4,4′-biphenol, or a combination thereof.

23. The polymer composition of claim 1, wherein the liquid crystalline polymer is wholly aromatic.

24. The polymer composition of claim 1, wherein the liquid crystalline polymer contains repeating units derived from 6-hydroxy-2-naphthoic acid in an amount of about 30 mol. % or more.

25. The polymer composition of claim 1, wherein the liquid crystalline polymer contains repeating units derived from 6-hydroxy-2-naphthoic acid in an amount of about 40 mol. % or more.

26. The polymer composition of claim 1, wherein the liquid crystalline polymer contains repeating units derived from 6-hydroxy-2-naphthoic acid and 4-hydroxybenzoic acid in a molar ratio of from about 15 to about 40.

27. The polymer composition of claim 1, wherein the liquid crystalline polymer comprises structural units represented by the respective formulae (I), (II), (III), and (IV), in amounts of 40 to 75% by mole of the structural unit (I), 8.5 to 30% by mole of the structural unit (II), 8.5 to 30% by mole of the structural unit (III), and 0.1 to 8% by mole of the structural unit (IV) to all the structural units: 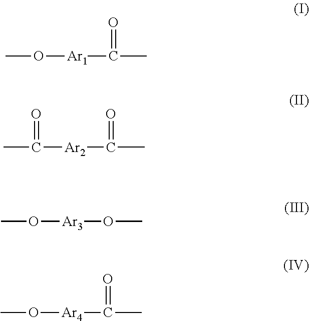
where Ar₁ is 2,6-naphthalene, Ar₂ is at least one group selected from the group consisting of 1,2-phenylene, 1,3-phenylene, and 1,4-phenylene, Ar₃ is at least one group selected from the group consisting of 1,3-phenylene, 1,4-phenylene, and a residue of a compound having two or more phenylene groups bonding with each other at the respective para-positions, and Ar₄ is 1,4-phenylene.

28. The polymer composition of claim 1, wherein thermally conductive fillers constitute less than 40 wt. % of the composition.

29. The polymer composition of claim 1, wherein the polymer composition exhibits a melt viscosity from about 10 Pa-s to about 200 Pa-s as determined at a shear rate of 1,000 seconds⁻¹.

30. The polymer composition of claim 1, wherein the polymer composition exhibits a dielectric constant from about 2 to about 4 when measured at a frequency of 10 GHz.

31. The polymer composition of claim 1, wherein the composition is formed by melt blending a carbon black masterbatch containing the carbon black particles with the liquid crystalline polymer.

32. The polymer composition of claim 31, wherein the carbon black masterbatch comprises from about 15 wt. % to about 60 wt. % of the carbon black particles and from about 40 to about 85 wt. % of a liquid crystalline polymer.

33. The polymer composition of claim 31, wherein the carbon black masterbatch has a surface resistivity of about 1×10² ohms or greater.

34. A film containing the composition of claim 1.

35. A laminate comprising the film of claim 34 and a conductive layer adjacent to the film.

36. An antenna comprising a circuit board containing the laminate of claim 35 and antenna elements.

37. A connector comprising a molded part formed from the composition of claim 1.
